(19) United States
(12) Patent Application Publication
(10) Pub. No.: US 2013/0298012 A1
(43) Pub. Date: Nov. 7, 2013

(54) Document Design Capture and Reuse System

(71) Applicants: David Neil Slatter, Bristol (GB); Andrew Hunter, Bristol (GB); Darryl Greig, Fishponds (GB)

(72) Inventors: David Neil Slatter, Bristol (GB); Andrew Hunter, Bristol (GB); Darryl Greig, Fishponds (GB)

(21) Appl. No.: 13/880,287

(22) PCT Filed: Jan. 25, 2011
(86) PCT No.: PCT/US2011/022403

§ 371 Date: Apr. 18, 2013

(51) Int. Cl. G06F 17/21

(52) U.S. Cl. CPC G06F 17/212
USPC 715/243

(57) ABSTRACT

A system (2, 200) can include memory (4, 208) to stare computer executable instructions and a processing unit (6, 210) to access the memory and execute the computer executable instructions. The computer executable instructions can include a capture tool (14, 206) to import content (24, 222) into a design document (26, 212) and to logically group the content into a logical group, corresponding to a container. Dynamic behavior can be assigned to the container, in response to a user input, to control a layout of content within the container and to provide a source complex document (12, 202) stored in the memory to retain the dynamic behavior for editable content in the container.

### BACKGROUND

Tools exist for building and editing documents. However, many existing tools for retrieving and manipulating content from other sources can be difficult for many users to implement. For instance, some tools employ complex interfaces that may require detailed knowledge of the tool to build documents. Additionally, many systems are too constrained for producing document types with rich layouts to produce magazine-like pages and spreads.

### BRIEF DESCRIPTION OF THE DRAWINGS

FIG. 1 depicts an example of a system for design and re-use of a complex document.

FIG. 2 depicts an example of a system for design and re-use of a complex document.

FIG. 3 depicts an example of a complex document.

FIG. 4 depicts an example of a data structure representation of a complex document.

FIG. 5 depicts an example of another system for design and re se of a complex document.

FIG. 6 is a flow diagram depicting an example of a method for generating a layout for a complex document.

### DETAILED DESCRIPTION

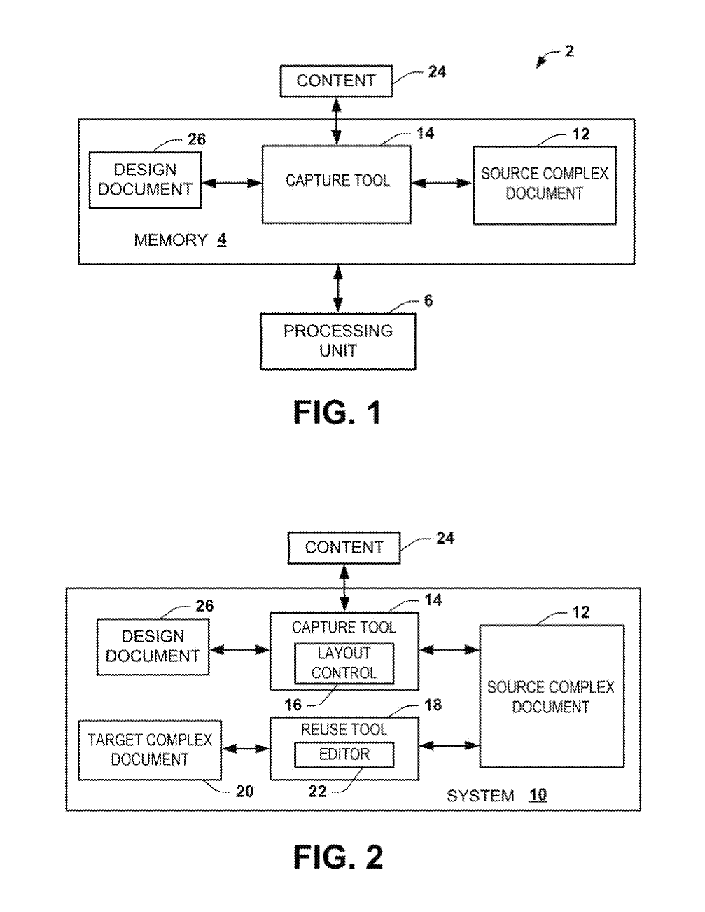

FIG. 1 depicts an example of a system 2 that can be utilized to design a complex document 12. The system 2 can include memory 4 to store machine readable instructions (including computer executable instructions). The system 2 can also include a processing unit 6 to access the memory 4 and execute corresponding machine readable instructions. In the example of FIG. 1, the processing unit 6 can execute machine readable instructions comprising a capture tool 14 to import content 24 into a design document 26. such as can be stored in the memory 4. The capture tool 14 can also logically group content into a logical group, corresponding to a container and to assign dynamic behavior to the container, in response to a user input to control a layout of content within the container. The capture tool 14 can provide the source complex document 12 to retain the dynamic behavior for editable content in the container. The source complex document 12 can be stored in the memory 4, such as for re-use by a user.

FIG. 2 depicts an example of a system 10 that can be utilized to design and re-use a complex document 12. The system 10 includes a capture tool 14 that can be employed to generate a source complex document 12. For instance, the capture tool includes a layout control 16 that a designer-user can employ to selectively group elements and to assign dynamic behavior to a given group of elements. The assigned dynamic behavior can be stored as part of the source complex document 12.

As used herein, the term “includes” means includes but not limited to, the term “including” means including but not limited to. The term “based on” means based at least in part on,

The capture tool 14 can access content 24 from a content source, which content may exist in any of a variety of content types and file formats. The capture tool 14 can retrieve the content and store it as a design document 26. The layout control 16 of the capture tool can be utilized to modify the dynamic behavior of content and groups of content in the design document. For instance, a designer-user (e.g., a professional designer person) can consider how groups of content elements should be laid out if subjected to content changes. The designer-user can thus employ the layout control 16 to assign dynamic behavior to selected blocks of content in the design document. As an example, the dynamic behavior can be implemented as a layout engine, and the system 10 may implement any number and type of layout engines. The designer-user can assign a layout engine (e.g., selected from a list of available algorithms) to the selected blocks of content in design document 26. The designer-user can employ the capture tool to publish the resulting design document and its associated dynamic behavior as the source complex document 12.

The system 10 also includes a re-use tool 18 that can be utilized to access the source complex document 12 and store the document within an editable target complex document 20. For instance, the re-use tool 18 includes an editor 22 that can manipulate content in the target complex document, which manipulation can include adding content, removing content or changing properties of content. The re-use tool 18 is programmed to adapt the layout of the target complex document without changing the dynamic behavior that the designer had assigned via the capture tool 14.

In this way, a less sophisticated user can employ the re-use tool to produce rich pleasing professional looking layouts, based on the arrangement and behaviors of complex documents designed by more sophisticated designer-users (e.g., professional designers using the capture tool 14) who are more skilled in the aesthetics of complex document design and design interfaces.

As used herein, a complex document refers to a document that contains a group of content elements selected from the group comprising text elements, graphical elements, multimedia (e.g., audio, video, or audio-video) elements and image elements residing in containers with associated layout formats. An image element is a pixel array, such as, for example, a photo. A graphical element can be a pixel array but may often have a vector representation (including scalable vector graphics (SVG)) associated with the graphical. The vector representations are readily scaleable without the loss of quality. Graphical elements can be used for borders and decoration, color gradients, logos, diagrams and the like. A text element can be a block of text, page number, a figure index or a header. Text of a header can include an emphasis, such as large text, bolding, underling, etc. and a tag (e.g., specified by a designer a priori) to identify that it is to be put at a top of a layout or arranged first in a layout. The layout of these elements can be fully two dimensional, such that it is not restricted to folding a one dimensional thread of characters and images into a fixed column or page of the complex document.

Additionally, the modifier “source” in the term “source complex document” is intended to indicate that the document is to be used as a source of content. As such, the source complex document can be write-protected upon its creation, such that any part or the entire document can be copied into a target complex document without causing changes to the source complex document. The modifier “target” in the term “target complex document” is intended to indicate that the document is an editable document, the content of which a user can manipulate. As mentioned above, however, the dynamic behavior (e.g., a layout engine) that is assigned to a container in a corresponding source complex document remains unchangeable by the user in the target complex document.

Each complex document 12 and 20 can further be represented for computation by a hierarchical structure of containers and content elements. As used herein, a container refers to a structure having a layout format that can hold a group of one or more of the elements 16. Each container can further include a container-specific layout engine and layout parameters (e.g., layout rules) to be used to arrange elements therein, as specified via the capture tool 14. The container-specific layout engine arranges and modifies the elements in its container to fill the shape and size of the available surface (e.g., page) by applying rules to elements and their properties. Examples of types of layout engines include a Blocked Recursive image Composition (BRIC) layout engine, a columnar layout engine, as well as other types of dynamic layout techniques (and associated algorithms).

A container can include one or more other containers nested therein to support complex documents which define nested layouts. Examples of containers include pages, spreads including two facing pages, a group of images, a group of images with titles and others. The resulting document structure for each complex document 12 and 20 thus can be described as a multi-level hierarchical dynamic layout.

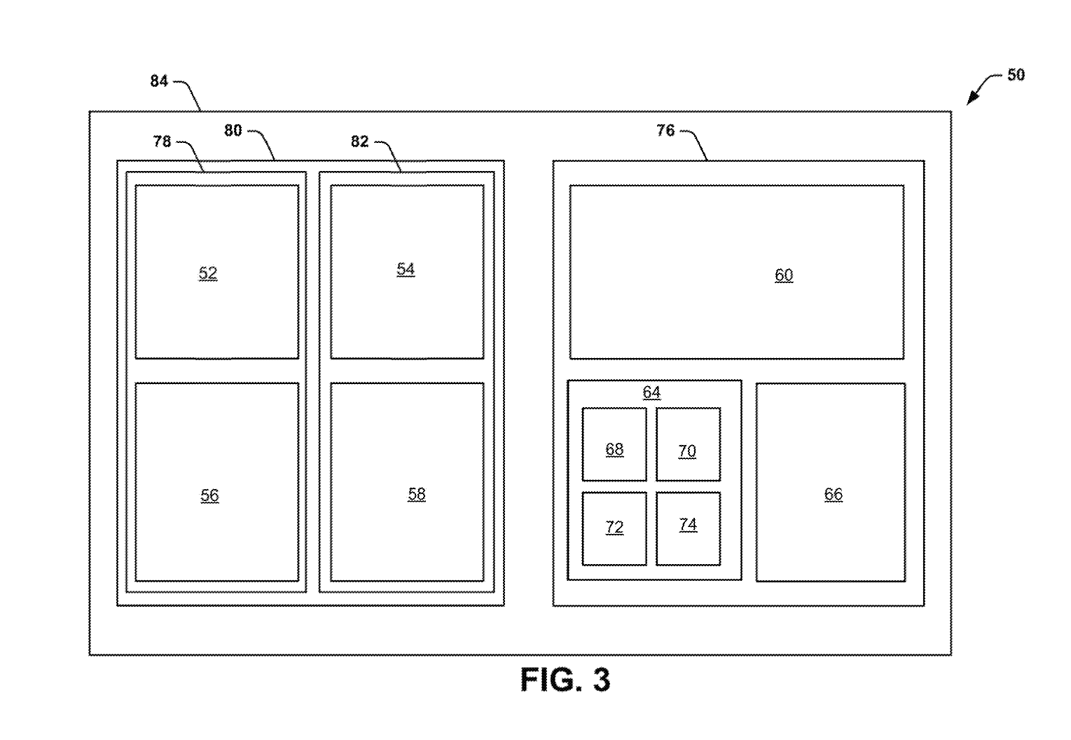

By way of example, FIG. 3 illustrates an example block diagram of a complex document 50, such as the source complex document 12 that can be generated by the capture tool 14 of FIG. 1 or 2 and the corresponding target complex document 20. In the example of FIG. 3, the complex document 50 includes an arrangement of elements 52, 54, 56, 58, 60. 62, 64, 56, 67, 70, 72 and 74, such as can include image elements, text elements and layout elements. The elements 68, 70, 72 and 74 reside within a nested layout 64, such as can any desired type of layout element (e.g., a BRIG layout). The nested layout element 64, content element 60 and content element 66 reside within a page layout container 76. The elements 52 and 56 reside in common column 78 of another page layout container 80, while 54 and 58 reside within yet another column 82 of the same page layout 80. The page layout containers 76 and 80 further reside in a spread layout 84 containing the two respective pages.

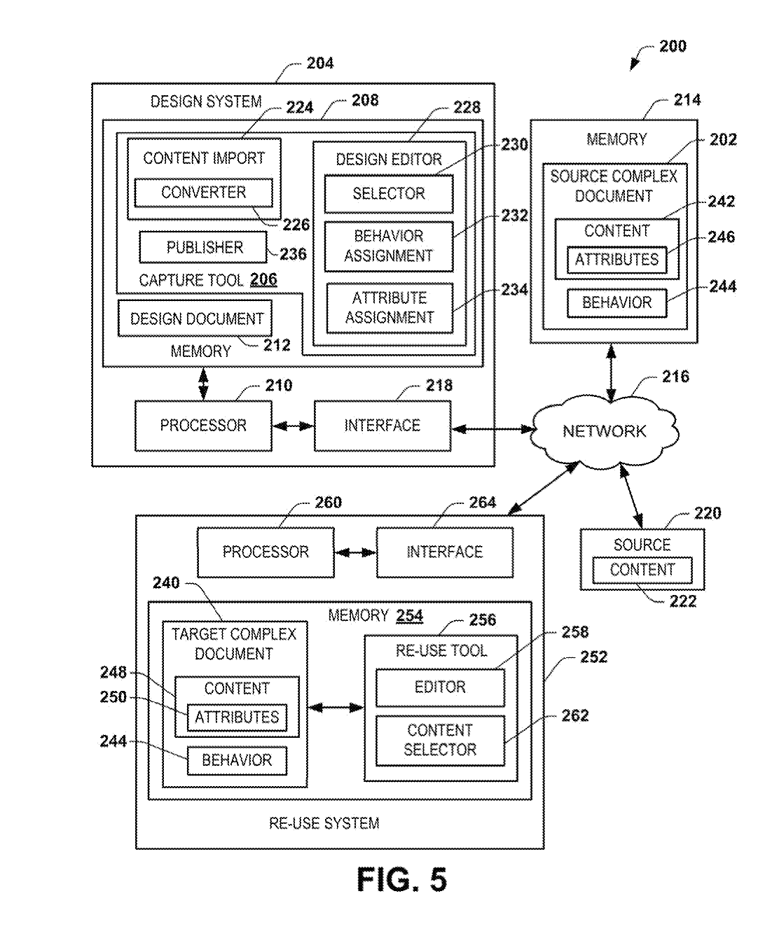

The content of the complex document 50 can be manipulated, such as via a re-use tool (e.g, re-use tool 18 of FIG. 2 or 256 of FIG. 5). The content manipulation can be movement of content elements 52, 54, 56, 58, 60, 62, 64, 66, 68, 70, 72 and 74 within the spread 84, adding new content into the spread, removing content elements from the spread and the like. In response to such user-manipulation of content, the layout engines for each container can re-calculate the layout thereof. The layout engines can apply to each of the content elements at lower levels of hierarchy according to the hierarchical structure of the complex document 50.

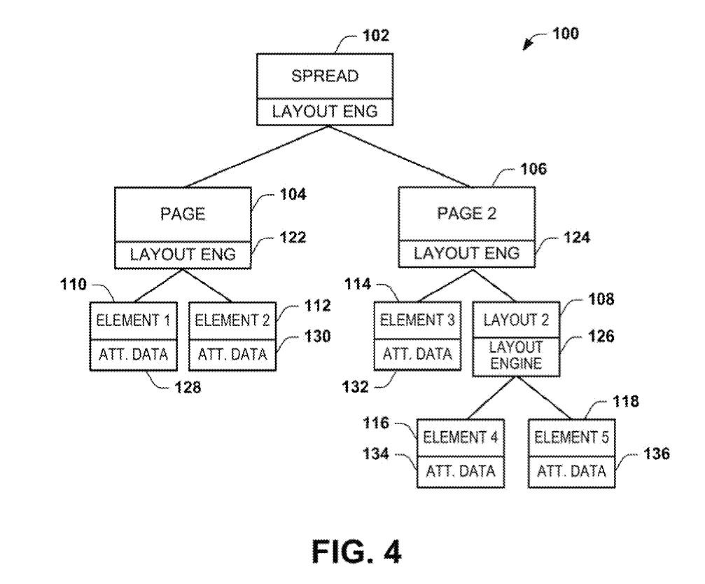

FIG. 4 depicts an example of a hierarchical document structure representation 100. In the example of FIG. 3, the data structure corresponds to a spread, although other types and formats of complex documents (e.g., a single page or poster) can be generated.

The data structure 100 can be represented as a binary tree having a plurality of container nodes 102, 104, 106 and 108 and a plurality of content nodes 110, 112, 114, 116 and 118. In the example of FIG. 4, the content nodes 110, 112, 114, 116 and 118 are implemented as leaf nodes corresponding to the container nodes 102, 104, 106 and 108. Each of the container nodes 102, 104, 106 and 108 includes a layout engine 120, 122, 124 and 126. The hierarchy of nodes in the data structure 100 prescribes the influence of each layout engine over the branches and child nodes under it in the hierarchy. Each layout engine 120, 122, 124 and 126 also determines the layout of elements (e.g., content elements or nested containers) that reside within each container based on attributes associated with each of the content elements.

In the example structure 100, the root node (“SPREAD”) 102 has two child nodes (“PAGE 1” and “PAGE 2”) 104 and 106. Content nodes (“ELEMENT 1” and “ELEMENT 2”) 110 and 112 are leaf nodes of the container node 104. The container node 106 has as its children content node (“ELEMENT 3”) 114 and container node 108. The container node 108 is itself a layout structure (“LAYOUT 2”) that includes the layout engine 126 to determine the resulting layout of its child leaf node elements (“ELEMENT 4” and “ELEMENT 5”) that are contained therein. Thus, the container node 108 corresponds to a nested layout, which can be any type of layout (e.g., a columnar layout a BRIC layout, etc.).

Each of the content elements 110, 112, 114, 116 and 118 includes associated attribute data 128, 130. 132, 134 and 136. The attributes can be assigned by a designer-user (e.g., via the capture tool 14 of FIG. 1 or 2). The attributes can specify an element type (e.g., an image type, text block, graphic and the like), layout constraints (e.g., position, size, logical relationships to other elements and the like) as well as authorship and revenue or cost associated with a given element. A given complex document can be formed of multiple spreads, which may be the same or different depending on the layout format of the container. The example of FIG. 4 demonstrates but one example of a hierarchical representation for a complex document that can be utilized. Various other structures and content can be utilized based on the teachings herein.

FIG. 5 depicts an example of another system 200 that can be implemented for design and re-use of a source complex document 202. The system 200 includes a design system 204 that can be implemented for a design phase that is utilized to create the source complex document 202. The design system 204 includes a capture tool 206. The capture tool 206 can be stored in memory 208 as computer readable instructions. A processor 210 can access the computer readable instructions, corresponding to the capture tool 206, and execute the instructions. For instance, the memory 208 can comprise physical memory such as can reside on the processor 210 (e.g., processor memory). random access memory, or other physical storage media (e.g, a CD ROM, DVD, flash memory, hard drive, etc.) or a combination of different memory devices that can store the computer readable instructions. The capture tool 206 can also utilize a design document 212 that can also be stored in the memory 208 for use in building the source complex document 202.

The source complex document 202 is also stored in associated memory 214. In this example implementation, the source complex document 202 and its associated memory 214 can be accessible by the design system 204 via a network 216. The network 216 can be any set of interconnected computers, such as may form a local area network, wide area network or other type of computing architecture (e.g., a cloud computing environment). The design system can employ the processor 210 and an associated interface 218 to access the memory 214 and data stored therein. Additionally, the interface 218 can be utilized to access a source 220 that may contain content 222 that can be utilized for generating the source complex document 202, as described herein.

In the example of FIG. 5, memory 214 is demonstrated as being different from and remotely located relative to the memory 208. Alternatively, the source complex document 202 can be stored within the design system 204, such as in the memory 208.

The capture tool 206 can include a content import component 224 that can be programmed to access and retrieve content 222 from the source of content 220. For example, the content import component 224 can access and retrieve content in one or more different forms in a response to user input instructions received at the capture tool 206. For instance, the content import component 224 can utilize a graphical user interface (GUI), such as a browser, a file management system or other existing tools to access the content (e.g., a document file) 222 from the content source 220. It is to be understood that while the content source 220 is depicted as being coupled to the network 216, the content source 220 and its content 222 can alternatively for additionally) be implemented within the design system 204. The content import component 224 thus can retrieve the content 222 and stored in the memory 208 as the design document 212. Thus the design document 212 can be stored as a document in a predetermined format that can be modified by the capture tool 206 for producing the corresponding source complex document 202.

As a further example, the content import component 224 can include a converter 226 to convert the content 222 retrieved from the content source 220 into a predetermined editable format. For instance, the converter can identify a plurality of primitive objects in the retrieved content 222 and integrally join such primitive objects into logical groupings of content. The converter 226 can also implement an automated interpretation of the content being retrieved, including an identification of blocks of content and a hierarchical relationship that can be utilized to form the hierarchically structured complex document. The logical groupings of content can be stored as the design document 212 in the memory 208.

For example, the content 222 can correspond to a portable document format (PDF) file or other document format that encapsulates a description of content in a fixed-layout document. The converter 226 thus can be programmed to parse the content 222 and identify primitive objects in the document and group such primitive documents by integrally joining them to form object blocks within the design document. Examples of object blocks can include images, text blocks (e.g., words, phrases). The amount of conversion and extent of the groupings of the primitive objects can vary depending upon the type and complexity of converter 226.

The capture tool 206 also includes a design editor 228 to logically group content, including the primitive objects and other groupings identified by the converter 226, into a corresponding a user-specified logical group, corresponding to a container. The design editor 228 further can assign behavior to each container of the design document and in turn construct a hierarchical document structure, in which a dynamic behavior can be specified for each level of the hierarchy.

In the example of FIG. 5, the design editor includes a selector 230 that can provide a GUI programmed to select blocks of content or objects in the design document in response to a user input. For example, a user can employ the selector 230 to select one or more content objects via a curser (or other pointing user interface element) based upon instructions received from a user input device. Selected objects can be grouped into a logical grouping of objects that define a container.

The design editor 228 can also include a behavior assignment component 232 that can be utilized to assign a desired dynamic behavior to a selected container in response to a user input. The dynamic behavior can be utilized to control a layout of content to a selected group of object blocks that reside within the container. For example, the dynamic behavior can include a layout engine that is selected (e.g., from a list of available layout engines) in response to a user input. The list of available layout engines that is presented to the designer-user can vary as a function of attributes of the content within a given container. For example, a different set of available layout engines may be presented to the designer-user for content that includes images only, text blocks only, or a combination of text and images.

Additionally, the designer-user can employ the behavior assignment component 232 to specify different layout engines at each level of hierarchy in the hierarchical document structure that forms the design document 212. Thus the dynamic behavior assigned via the behavior assignment component 232 can be utilized to maintain specified dynamic behavior of grouped objects consistent with the intent of the designer-user.

The designer editor 228 can also include an attribute assignment component 234. The attribute assignment component can be utilized to assign attributes to each of the elements or objects in the design document 212. The attributes, for example, can be assigned via a graphical user interface that comprises a list of element attributes. The list of available attributes for a given element or object can vary as a function of the layout engine assigned (e.g., via the behavior assignment component 232) to a container in which the given element or object resides. For example if a columnar layout has been assigned to a container in which a group of one or more objects has been placed, the attribute assignment component may provide a set of attributes related to the columnar layout, such as constraints on the number of columns, on the width of a given element or placement of the element in a respective column or in multiple columns. In this way, attributes can be easily specified for each of the elements in a given design document consistent with the dynamic behavior that has been assigned to such elements.

Examples of other element attributes that can be assigned via the attribute assignment component 234 can include assigning a heading attribute to a text block (e.g., so that it operates as a heading in a resulting layout), or other logical groupings between pairs of elements that can control a sequence, relative order or alignment of such elements with respect to each other. The behavior and attributes specified via the design editor 228 can be stored with the design document 212, as part of the document's hierarchical structure, in the memory 208.

The capture tool 206 also includes a publisher 236 that can be utilized to store the source complex document 202, corresponding to the completed design document 212, in the memory 214. The publisher can publish the source complex document for subsequent user access (e.g., by a reuse tool 256) automatically upon creation of the design document 212 or in response to a user input request. Once a source complex document 202 has been published, it may be accessible by one or other users for generating a corresponding target complex document 240. The source complex document 202 thus includes an arrangement of content 242 and dynamic behavior 244 that controls the layout of the content. The behavior 244 further can vary based upon content attributes 246 that has been assigned to the elements Of groups of elements in the content 242. In this way, a user can access and utilize the content and layout of the source complex document so that reuse of the dynamic behavior of the source complex document is facilitated when the source complex document is copied into the target complex document 240.

In addition to the behavior 244, the target complex document 240 can include content 248 as well as attributes 250 for its content elements. The content 248 and content elements 250 can vary from that of the source complex document 202. However, the dynamic behavior 244 of the groups of elements copied to the target complex document 240 remains unchanged while the layout can automatically adapt to changes in the content 248, which can include changes in content elements 250 and/or containers. As one example, a user can employ a re-use tool 256 to arbitrarily insert container into other containers within the target complex document 240. While the way that a particular container lays out its children does not change, the apparent dynamic behavior of a page container (or a document container) can change because of changes to its children. For instance, the new children can have different intrinsic dynamic behavior from the previous children.

As an example, the system 200 can include a re-use system 252 that can access and retrieve the source complex document 202 and store it in memory 254 as the target complex document 240. The target complex document 240 can include content 248 and dynamic behavior information 244. While, as mentioned above, the dynamic behavior information 244 remains unchanged, the content 248 and element attributes 250 can vary from that of the source complex document.

In the example of FIG. 5, the re-use system 252 includes a re-use tool 256 that is programmed to manipulate the target complex document 240 according to user selected content. The re-use tool 256 can include an editor 258 that can be utilized to manipulate content of the target complex document 240. For instance, the editor 258 can be implemented as including a GUI e.g., modify, add, or remove content and properties of) the target complex document, which can be stored in memory 254. Such manipulation of content can also involve retrieving content elements from the one or more other source of content (e.g., the source 220) or from any source that may be accessible via the re-use system 252, including within the memory 254 or other media storage that may be accessible via the re-use system. In response to user-manipulation of content 248 via the editor 258, including adding, removing or otherwise modifying content or content properties, the behavior information (e.g., layout engines) of the target complex document can automatically adapt the layout of the content 248 in response to such manipulation. Alternatively, such adaptation can be initiated in response to a user input. In this way, while content can be changed for the target complex document 240, the dynamic behavior 244 of groups of elements copied to the target complex document remains unchanged as to maintain the designer's original intent and aesthetic properties of the source complex document 202.

The re-use tool 256 includes a content selector 262 that can be utilized to select elements in the complex target document 240. A user can employ the content selector 262 to select content elements for manipulation of the target complex document 240, such as including further manipulation of content elements, containers and combinations thereof. For instance, the content selector 262 can be implemented as including a GUI that can select containers and elements within the target complex document 240 via a curser or other pointing element, such as to modify a position or properties of selected content as well as to change or add content from another content source (e.g., from a source complex document in the re-use system 252).

As demonstrated in the example of FIG. 5, the re-use system 252 also includes a processor 260 that can access the computer-readable instructions stored in the memory 254 (e.g., comprising the re-use tool 256) for executing the functions described herein associated with the re-use tool 256. The re-use system 252 can also employ an associated interface 264 to access the complex source document via the network 216 and to access content 222 located in the content source 220. In this way, by employing the target complex document retrieved from the source complex document 202, a user can utilize the dynamic behaviors (e.g., layout engines) that were provided via the capture phase using the capture tool for user-specified content. The target complex document 240 can thus employ the dynamic behavior to adapt the design to new content as well as shuffle and selected containers without affecting the aesthetic design choices imposed on the document via the dynamic behavior imposed by the designer-user at each level of hierarchy of the hierarchical structural document.

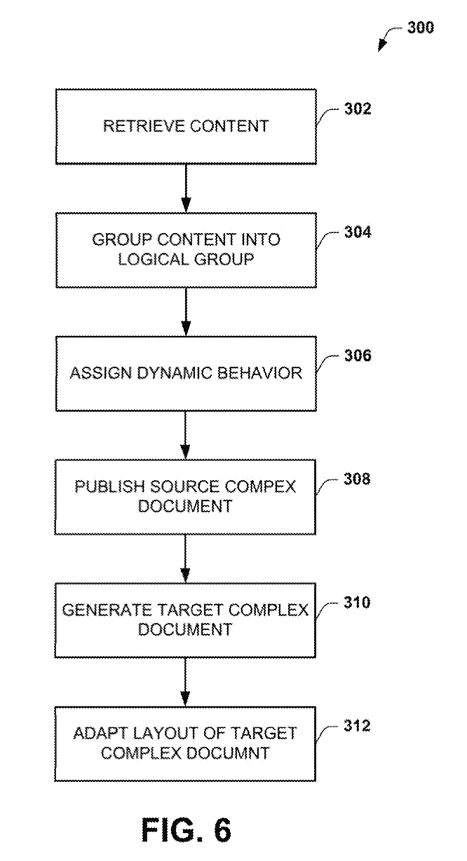

In view of the foregoing structural and functional features described above, an example method will be better appreciated with reference to FIG. 6. While, for purposes of simplicity of explanation, the example method of FIG. 6 is shown and described as executing serially, it is to be understood and appreciated that the examples are not limited by the illustrated order, as some actions could in other examples occur in different orders and/or concurrently from that shown and described herein. The method of FIG. 6 can be implemented as computer executable instructions executed by a processor (e.g., the processor 6 of FIG. 1; processor 210 and/or 260 of FIG. 5) or as computer readable data stored in memory (e.g., memory 4 of FIG. 1; memory 208 and/or 254 of FIG. 5).

FIG. 6 depicts an example of a method 300 for design and re-use of a complex document. At 302, the method includes retrieving content from a content source (e.g., a remote or local source stored content, such as content 24 of FIG. 1 or 2, or content 222 of FIG. 5). At 304, retrieved content is grouped (e.g., via the selector 230 of FIG. 5) into a logical group, corresponding to a container. At 306, dynamic behavior is assigned to the container (e.g., via the behavior assignment component 232 of FIG. 5), in response to a user input, to control a layout of content elements residing within the container. At 308, a source complex document is published (e.g., published for re-use via the publisher 236 of FIG. 5) to retain the dynamic behavior for content in each container thereof. At 310, an editable target complex document is generated (e.g., via the re-use tool 18 of FIG. 2 or 256 of FIG. 5) based on the source complex document. At 312, the layout of the content in the target complex document is adapted in response to user manipulation of content according to the assigned dynamic behavior.

What have been described above are examples. It is, of course, not possible to describe every conceivable example of the invention, but one of ordinary skill in the art will recognize that other example embodiments are possible. Accordingly, this disclosure is intended to embrace all embodiments, such as including alterations, modifications, and variations that fall within the scope of the appended claims. Additionally, where the disclosure or claims recite “a first,” or “another” element, or the equivalent thereof, it should be interpreted to include one or more than one such element, neither requiring nor excluding two or more such elements.

What is claimed is:

1. A system (2, 200) comprising:
memory (4, 208) to store computer executable instructions; and
a processing unit (6. 210) to access the memory and execute the computer executable instructions, the computer executable instructions comprising:
a capture tool (14, 206) to import content (24, 222) into a design document (26, 212) and to logically group the content into a logical group, corresponding to a container, dynamic behavior being assigned to the container, in response to a user input, to control a layout of content within the container and to provide a source complex document (12, 202) stored in the memory to retain the dynamic behavior for editable content in the container.

2. The system of claim 1, wherein the capture tool (206) further comprises a content import component (224) to retrieve the content from a content source (220) selected in response to a user input, the retrieved content being stored in the memory.

3. The system of claim 2, wherein the capture tool (206) further comprises a converter (226) to convert the content retrieved from the content source (220) into a plurality of primitive objects and to join the plurality of primitive objects to form the logical group of content stored in the memory as the design document, the capture tool publishing the design document for re-use as the source complex document.

4. The system of claim 3, further comprising a design editor(228) to provide a graphical user interface, the design editor comprising:
a selector (230) to select a group of object blocks from the source document in response to a user input; and
a behavior assignment component (232) to assign dynamic behavior to the selected group of the object blocks.

5. The system of claim 4, wherein the dynamic behavior comprises a layout engine selected in response to a user input.

6. The system of claim 5, wherein the source complex document (202) comprises a hierarchical structure that defines a hierarchy for each group of the object blocks, corresponding to a respective container, the behavior assignment component (232) being programmed to assign a user-selected layout engine to each respective container in the design document.

7. The system of claim 5, further comprising an attribute assignment component (234) to assign an attribute to a user-selected content element in the design document.

8. The system of claim 3, wherein the content (222) retrieved from the content source comprises a PDF file.

9. The system of claim 1, wherein the computer executable instructions further comprise a re-use tool (256) to access the source complex document and store the source complex document as an editable target complex document (240), the re-use tool being programmed to manipulate the content in the target complex document in response a user input such that the layout adapts automatically in response to the user input, without changing the dynamic behavior (244) assigned to each grouping of content.

10. The system of claim 9, wherein the dynamic behavior (244) comprises a layout engine, the target complex document (240) comprising hierarchical structure that defines a hierarchy for each container in the target complex document, each container maintaining the layout engine assigned to the source complex document via the capture tool (206).

11. A computer readable medium having computer executable instructions comprising:
a capture tool (14, 206) to create a source complex document (12, 202) from designer-specified content retrieved from a content source (24, 220). the capture tool being operative to logically group content into a logical group, corresponding to a container, to assign dynamic behavior to the container, in response to a user input, to control a layout of content elements residing within the container, and to provide the source complex document retaining the dynamic behavior for editable content in the container; and
a re-use tool (18, 256) comprising an editor (22, 258) to access the source complex document (12, 202) and store the source complex document as an editable target complex document (20, 240) comprising the dynamic behavior (244), the editor being programmed to manipulate content in response to user input, such that the layout of the content in the target complex document adapts to the manipulation of content according to the dynamic behavior assigned via the capture tool and without modifying the dynamic behavior in response to the manipulation of content.

12. The computer readable medium of claim 11, wherein the capture tool (206) further comprises:
a content import component (224) to retrieve content from the content source selected in response to a designer-user input, the retrieved content being stored in the memory (208) as a design document (212), the capture tool further comprising:
a converter (226) to convert content retrieved from the content source into a plurality of objects and to join the plurality of objects into the logical group, the logical group being stored in memory as a design document, the design document being published for re-use as the source complex document (202) with the dynamic behavior.

13. The computer readable medium of claim 12, wherein the capture tool (206) further comprises a behavior assignment component (232) to assign the dynamic behavior to each logical group of designer-selected objects residing in a respective container of the design document.

14. The system of claim 12, wherein the design document (212) comprises a hierarchically structured document that defines a hierarchy for each container thereof, the capture tool (206) further comprising a behavior assignment component (232) to assign a designer-user-selected layout engine to each respective container at each level of the hierarchy of the design document.

15. A method (300) comprising:
retrieving content from a content source (302);
logically grouping the retrieved content into a logical group, corresponding to a container (304),
assigning dynamic behavior to the container, in response to a user input, to control a layout of content elements residing within the container (306);
publishing a source complex document to retain the dynamic behavior for content in each container (308);
generating an editable target complex document based or the source complex document (310); and
adapting the layout of the content in the target complex document in response to user manipulation of content according to the assigned dynamic behavior (312).
